(19) United States
(12) Patent Application Publication
(10) Pub. No.: US 2015/0102902 A1
(43) Pub. Date: Apr. 16, 2015

(54) Bluetooth Remote-Control Electronic Lock

(71) Applicant: Jie-Fu Chen, Chiayi City (TW)

(72) Inventor: Jie-Fu Chen, Chiayi City (TW)

(21) Appl. No.: 14/055,295

(22) Filed: Oct. 16, 2013

(51) Int. Cl. G07C 9/00

(52) U.S. Cl. CPC G07C 9/00039; G07C 9/00111
USPC 340/5.54

(57) ABSTRACT

A Bluetooth remote-control electronic lock contains an electronic locking unit including a controlling unit; an infrared identifying unit connecting with the controlling unit, wherein after identifying a user, the controlling unit executes wireless Bluetooth transmission; a lock control unit coupling with the controlling unit, the lock control unit including an anti-theft module; and a Bluetooth receiving unit disposed in a remote set phone. After the controlling unit pairs with the Bluetooth receiving unit, the Bluetooth receiving unit keys in the at least one security password, and at least one inputted password is checked if it matches with the at least one security password, when the at least one inputted password matches with the at least one security password, the electronic locking unit unlocks the door, and when the at least one inputted password doesn't match with the at least one security password, the electronic locking unit remains locking the door.

### BACKGROUND OF THE INVENTION

1. Field of the Invention

The present invention relates to a Bluetooth remote-control electronic lock which is capable of overcoming the shortcomings of the conventional mechanical lock or the conventional electronic lock.

2. Description of the Prior Art

A conventional mechanical lock or conventional electronic lock is applied to lock a door. However, the conventional mechanical lock is broken by a thief or a burglar easily without transmitting an instant alert.

The present invention has arisen to mitigate and/or obviate the afore-described disadvantages.

### SUMMARY OF THE INVENTION

The primary object of the present invention is to provide a Bluetooth remote-control electronic lock which is capable of overcoming the shortcomings of common mechanical lock or the conventional electronic lock.

To obtain the above objectives, a Bluetooth remote-control electronic lock contains:

an electronic locking unit including a controlling unit for providing wireless Bluetooth transmission function and controlling the electronic locking unit to unlock or lock a door;

an infrared identifying unit disposed on a predetermined position of an outer surface thereof and connecting with the controlling unit, the infrared identifying unit being used to identify a user, and after identifying the user, the controlling unit executing wireless Bluetooth transmission;

a lock control unit secured in the electronic locking unit and coupling with the controlling unit, the lock control unit including an anti-theft module so that the controlling unit starts and provides at least one security password;

a Bluetooth receiving unit disposed in a remote set phone for simultaneously pairing with and remotely receiving the controlling unit. After the controlling unit simultaneously pairs with the Bluetooth receiving unit of the remote set phone, the Bluetooth receiving unit keys in the at least one security password, and at least one inputted password is checked if it matches with the at least one security password, when the at least one inputted password matches with the at least one security password, the electronic locking unit unlocks the door, and when the at least one inputted password does not match with the at least one security password, the electronic locking unit remains locking the door.

Thereby, after the infrared identifying unit of the electronic locking unit detects the user's profile, the controlling unit simultaneously pairs with the Bluetooth receiving unit of the remote set phone, wherein when the at least one inputted password is the at least one security password, the electronic locking unit executes the unlocking process; and when the at least one inputted password is not the at least one security password, the controlling unit remains in the locking state. Accordingly, the Bluetooth remote-control electronic lock has protective security.

### BRIEF DESCRIPTION OF THE DRAWINGS

FIG. 1 is a perspective view showing the assembly of a Bluetooth remote-control electronic lock according to a preferred embodiment of the present invention.

FIG. 2 is a plan view showing the assembly of the Bluetooth remote-control electronic lock according to the preferred embodiment of the present invention.

FIG. 3 is a diagram showing the assembly of the Bluetooth remote-control electronic lock according to the preferred embodiment of the present invention.

FIG. 4 is a flow chart showing the operation of the Bluetooth remote-control electronic lock according to the preferred embodiment of the present invention.

FIG. 5 is a flow chart showing the operation of the Bluetooth remote-control electronic lock according to the preferred embodiment of the present invention.

FIG. 6 is a flow chart showing the operation of a Bluetooth remote-control electronic lock according to another preferred embodiment of the present invention.

FIG. 7 is another flow chart showing the operation of the Bluetooth remote-control electronic lock according to another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

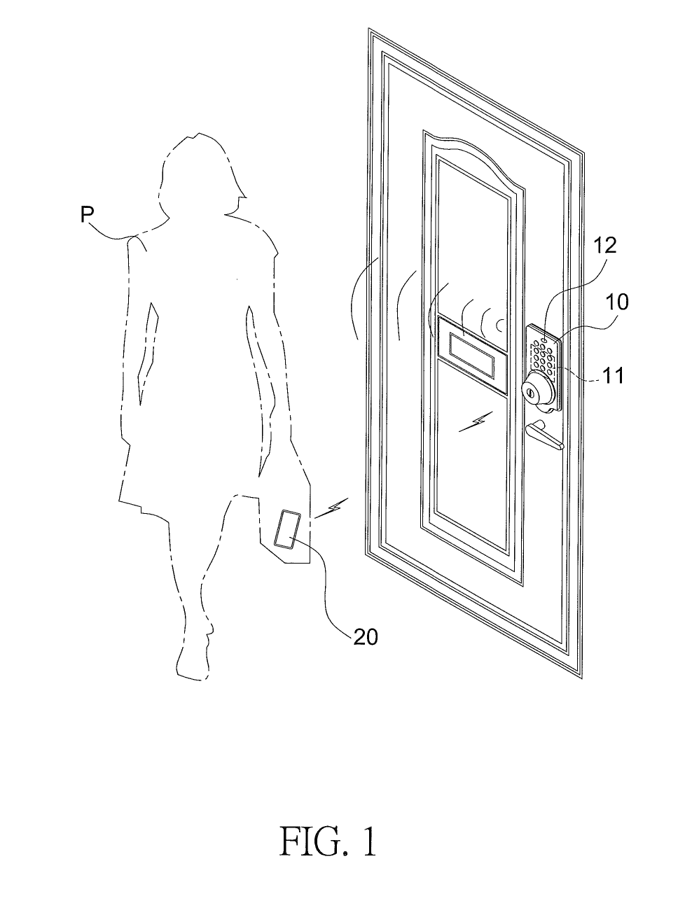

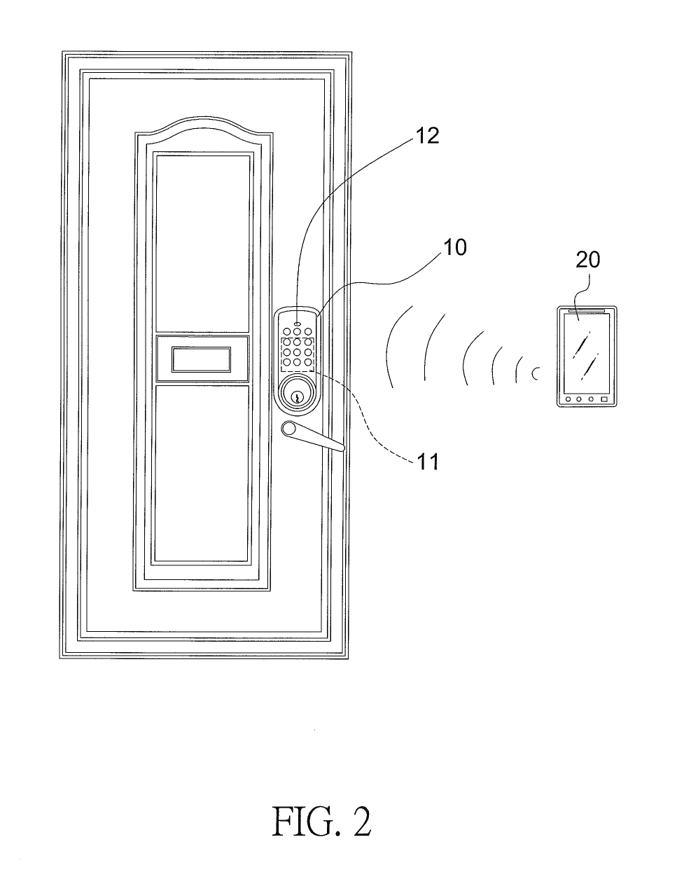

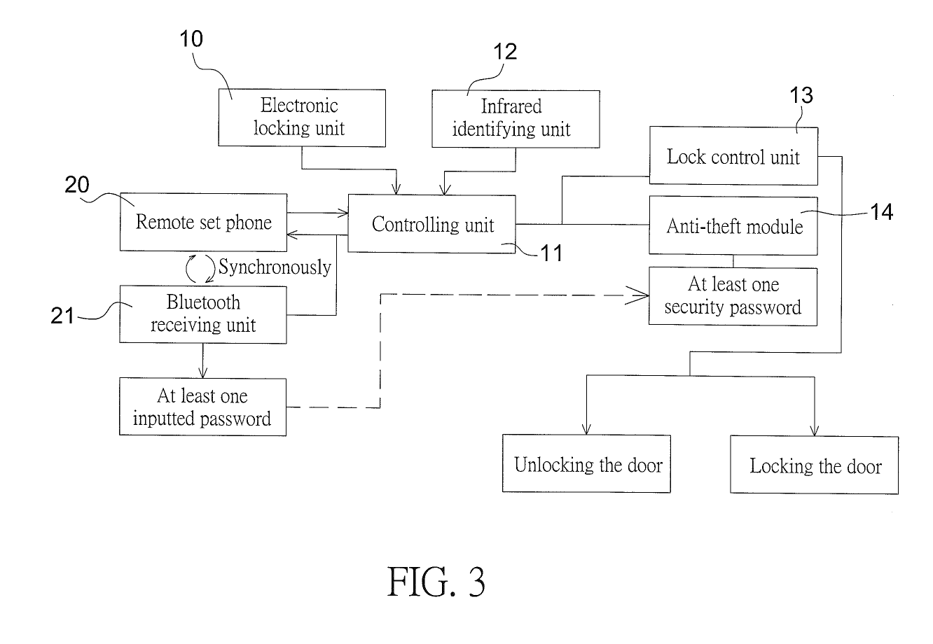

With reference to FIGS. 1-5, a Bluetooth remote-control electronic lock according to a preferred embodiment of the present invention comprises:

an electronic locking unit 10 including a controlling unit 11 for providing wireless Bluetooth transmission function and controlling the electronic locking unit 10 to unlock or lock a door; wherein after the controlling unit 11 controls the electronic locking unit 10 to unlock the door, it locks the door and enters a sleeping mode;

an infrared identifying unit 12 disposed on a predetermined position of an outer surface thereof and connecting with the controlling unit 11, the infrared identifying unit 12 being used to identify a user P, and after identifying the user P, the controlling unit 11 executes wireless Bluetooth transmission;

a lock control unit 13 secured in the electronic locking unit 10 and coupling with the controlling unit 11, the lock control unit 13 including an anti-theft module 14 so that when the controlling unit 11 starts and provides at least one security password, wherein the at least one security password is set by plural sets of codes;

a Bluetooth receiving unit 21 disposed in a remote set phone 20 for simultaneously pairing with and remotely receiving the controlling unit 11, wherein after the controlling unit 11 simultaneously pairs with the Bluetooth receiving unit 21 of the remote set phone 20, the Bluetooth receiving unit 21 keys in the at least one security password, and after the infrared identifying unit 12 identifies a user's profile P, at least one inputted password is checked if it matches with the at least one security password, when the at least one inputted password matches with the at least one security password, the electronic locking unit 10 unlocks the door, and when the at least one inputted password does not match with the at least one security password, the electronic locking unit 10 remains locking the door.

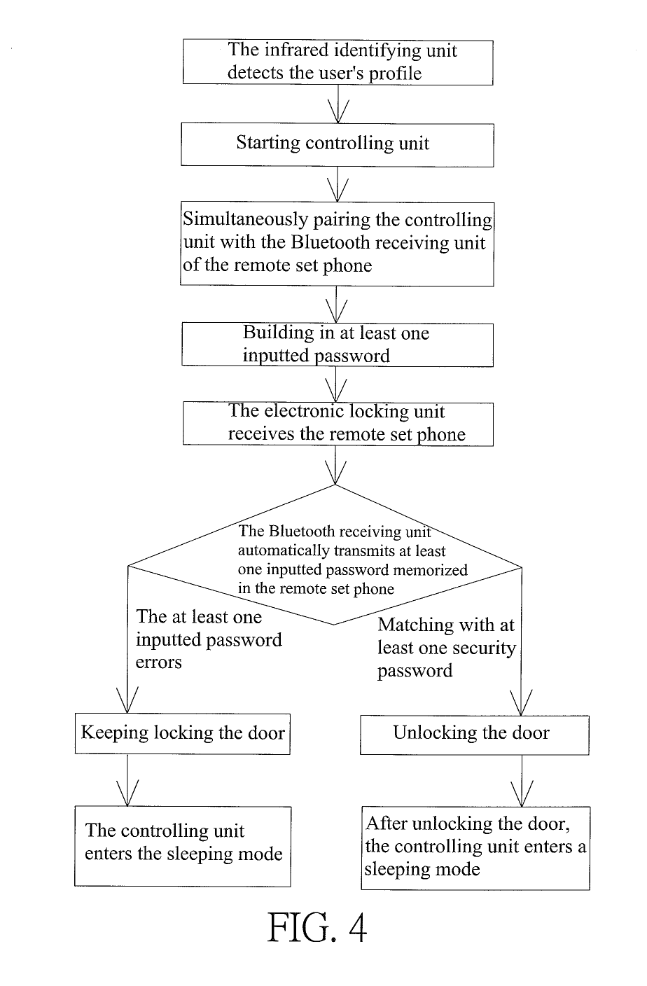

FIG. 4 is a flow chart showing the operation of the Bluetooth remote-control electronic lock according to the preferred embodiment of the present invention. When the user steps out of the elevator and walks to the door, the infrared identifying unit 12 of the electronic locking unit 10 detects the user's profile P and starts the controlling unit 11 so that the controlling unit 11 matches with the Bluetooth receiving unit 21 of the remote set phone 20 synchronously. Since the remote set phone 20 has a built-in password function in a pre-setting state, and after a receiving process of the electronic locking unit 10 and the remote set phone 20, the Bluetooth receiving unit 21 automatically transmits at least one inputted password memorized in the remote set phone 20 so that the electronic locking unit 10 determines if at least one inputted password in the remote set phone 20 complies with the at least one security password. If so, the electronic locking unit 10 executes an unlocking process, and a door opens automatically, thereafter the door closes and is locked by the controlling unit 11, in the meantime, the controlling unit 11 is in a sleeping mode. On the contrary, if the at least one inputted password in the remote set phone 20 does not comply with the at least one security password, the door cannot be opened and the controlling unit 11 is in the sleeping mode.

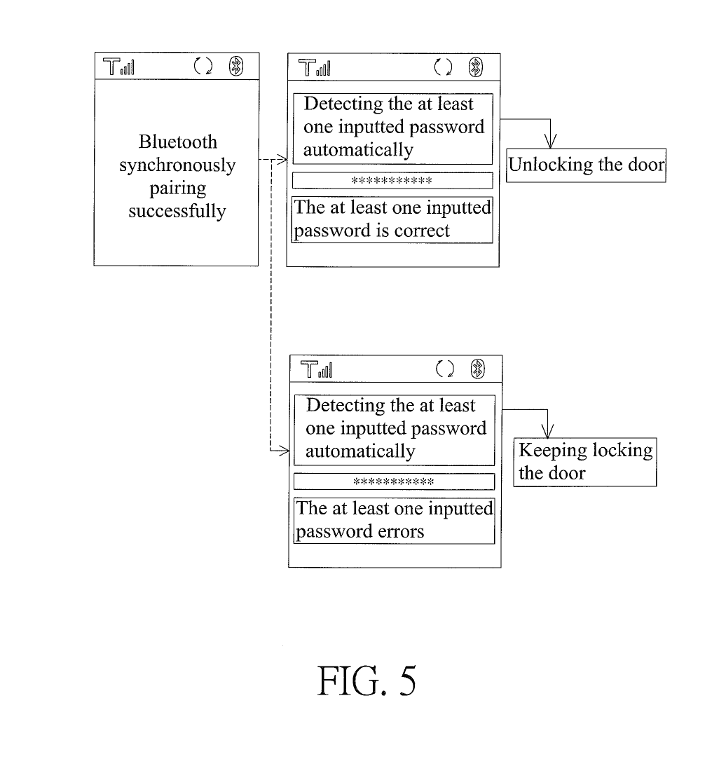

FIG. 5 is a flow chart showing the remote set phone 20 matches with the electronic locking unit 10, wherein after Bluetooth of the remote set phone 20 synchronously cooperates with the electronic locking unit 10, the remote set phone 20 displays a text screen, wherein when the at least one inputted password is the at least one security password, the text screen displays correct password so that the controlling unit 11 executes the unlocking process; and when the at least one inputted password is not the at least one security password, the text screen displays incorrect password so that the controlling unit 11 remains in a locking state.

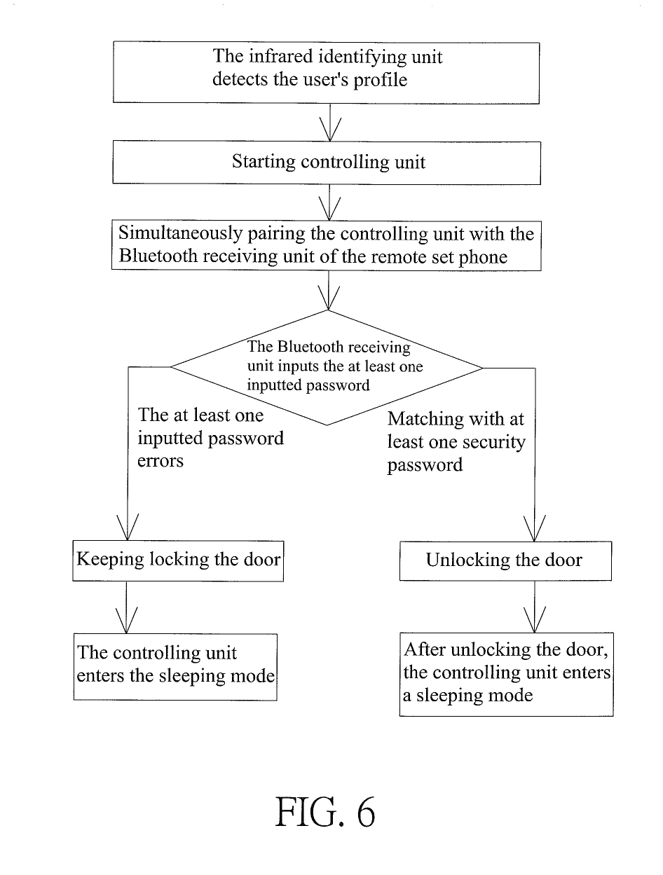

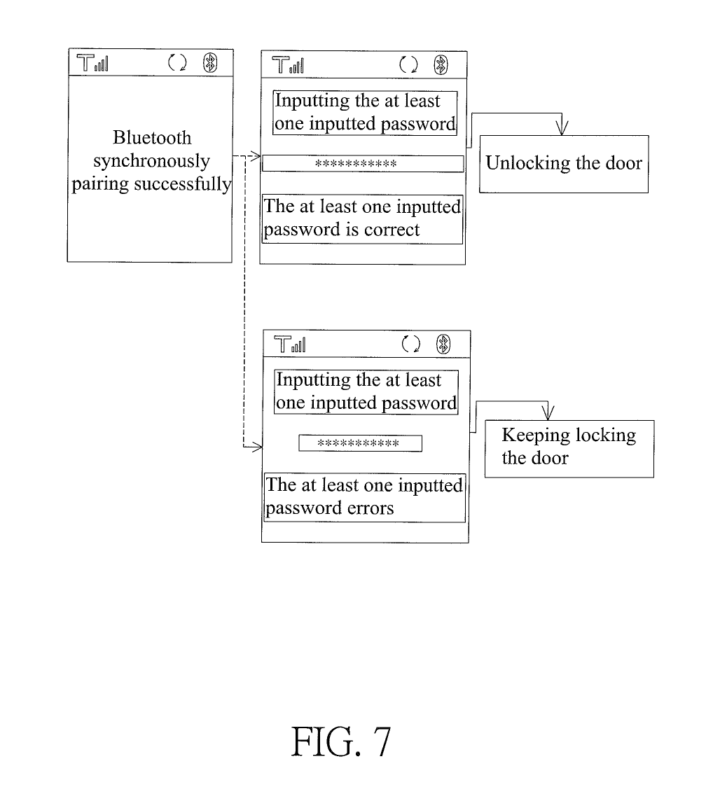

FIGS. 6 and 7 are a flow chart showing the operation of the Bluetooth remote-control electronic lock according to another preferred embodiment of the present invention, wherein the controlling unit 11 simultaneously pairs with the Bluetooth receiving unit 21 of the remote set phone 20, and the user manually keys at least one password into the Bluetooth receiving unit 21 of the remote set phone 20 when the infrared identifying unit 12 identifies the user's profile P, wherein when the at least one inputted password is the at least one security password, the controlling unit 11 executes the unlocking process; and when the at least one inputted password is not the at least one security password, the controlling unit 11 remains in the locking state.

Thereby, after the infrared identifying unit 12 of the electronic locking unit 10 detects the user's profile P, the controlling unit 11 simultaneously pairs with the Bluetooth receiving unit 21 of the remote set phone 20, wherein when the at least one inputted password is the at least one security password, the electronic locking unit 10 executes the unlocking process; and when the at least one inputted password is not the at least one security password, the controlling unit 11 remains in the locking state. Accordingly, the Bluetooth remote-control electronic lock has protective security.

While we have shown and described various embodiments in accordance with the present invention, it is clear to those skilled in the art that further embodiments may be made without departing from the scope of the present invention.

What is claimed is:

1. A Bluetooth remote-control electronic lock comprising:
an electronic locking unit including a controlling unit for providing wireless Bluetooth transmission function and controlling the electronic locking unit to unlock or lock a door;
an infrared identifying unit disposed on a predetermined position of an outer surface thereof and connecting with the controlling unit, the infrared identifying unit being used to identify a user, and after identifying the user, the controlling unit executing wireless Bluetooth transmission;
a lock control unit secured in the electronic locking unit and coupling with the controlling unit, the lock control unit including an anti-theft module so that when the controlling unit starts and provides at least one security password;
a Bluetooth receiving unit disposed in a remote set phone for simultaneously pairing with and remotely receiving the controlling unit, wherein after the controlling unit simultaneously pairs with the Bluetooth receiving unit of the remote set phone, the Bluetooth receiving unit keys in the at least one security password, at least one inputted password is checked if it matches with the at least one security password, when the at least one inputted password matches with the at least one security password, the electronic locking unit unlocks the door, and when the at least one inputted password does not match with the at least one security password, the electronic locking unit remains locking the door.

2. The Bluetooth remote-control electronic lock as claimed in claim 1, wherein the at least one security password is set by plural sets of codes.

3. The Bluetooth remote-control electronic lock as claimed in claim 1, wherein after the controlling unit controls the electronic locking unit to unlock the door, it locks the door and enters a sleeping mode; and after the controlling unit controls the electronic locking unit to keep locking the door, it is in the sleeping mode.

4. The Bluetooth remote-control electronic lock as claimed in claim 1, wherein after the controlling unit simultaneously pairs with the Bluetooth receiving unit of the remote set phone, the Bluetooth receiving unit keys in the at least one security password, and after the infrared identifying unit identifies a user's profile, at least one inputted password is checked if it matches with the at least one security password, when the at least one inputted password matches with the at least one security password, the electronic locking unit unlocks the door, and when the at least one inputted password does not match with the at least one security password, the electronic locking unit remains locking the door.
